(19) United States
(12) Patent Application Publication
(10) Pub. No.: US 2004/0196809 A1
(43) Pub. Date: Oct. 7, 2004

(54) Method and system for allowing an effective handover in a data transmission system in down-link data transmission

(76) Inventors: Markus Dillinger, Munchen (DE); Christian Salzmann, Munchen (DE)

Correspondence Address: BELL, BOYD & LLOYD, LLC, P. O. BOX 1135, CHICAGO, IL, 60690-1135, US

(21) Appl. No.: 10/486,303

(22) PCT Filed: Aug. 5, 2002
(86) PCT No.: PCT/EP02/08736

(30) Foreign Application Priority Data
Aug. 8, 2001 (DE) 10138916.7

(51) Int. Cl. H04Q 7/00

(52) U.S. Cl. 370/331; 370/400

(57) ABSTRACT

The invention relates to a method for carrying out a handover of a mobile terminal in a data transmission system. In the down-link direction (DL) of data exchange from the data transmission system to the mobile terminal (MT) the data (Data1, Data2) to be transmitted are forwarded in parallel to a plurality of data memories (P-RM, S-RM) within the data transmission system. Before handover (HO) takes place, data exchange is carried out by means of a first data memory (P-RM-DB2) and after handover by means of a second data memory (P-RM-DB3).

The present invention relates to a method for performing a handover of a mobile terminal in a data transmission system from a first transceiver device of the data transmission system to a second transceiver device during a data exchange between the data transmission system and the mobile terminal. Also described are a data transmission system having a plurality of transceiver devices and switching devices enabling data exchange with mobile terminals and a mobile terminal for a data transmission system having a plurality of transceiver devices and switching devices enabling data exchange with mobile terminals.

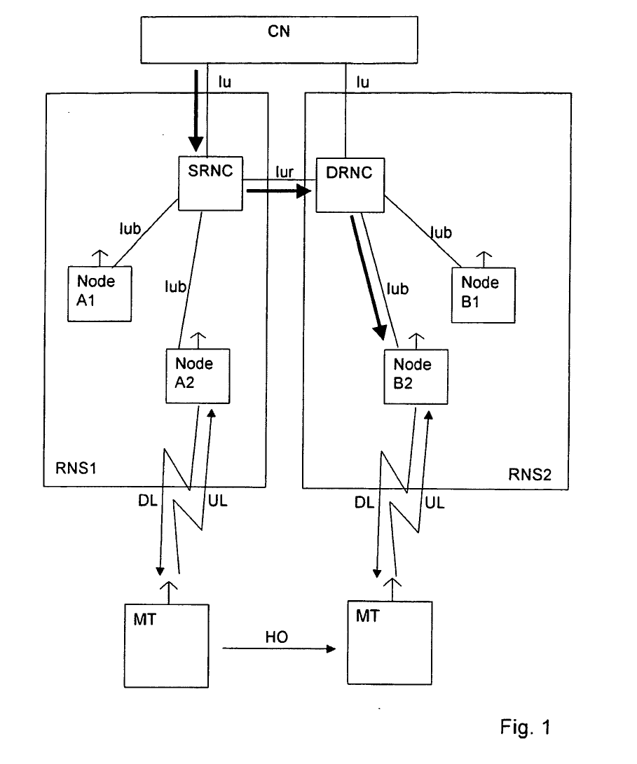

Mobile data transmission systems of this kind are sufficiently known from the prior art and implemented for example as second- or third-generation mobile radio networks (e.g. GSM, UMTS), local radio networks (e.g. DECT, HIPERLAN) or other data radio networks (e.g. GPRS). In this regard reference may be made by way of example to EP 0 766 490 A2, which describes a HIPERLAN network. Communication data such as, for example, voice data as well as other application data such as multimedia data or software programs and other software files can be conveyed in these data transmission systems. Handover methods for call forwarding for such data transmission systems are also essentially known from the prior art. A typical handover method according to the prior art is shown in FIG. 1 and will be explained below.

Mobile terminals for mobile data transmission systems are becoming increasingly more intelligent and the volumes of data exchanged between the mobile terminals and the data transmission system are growing all the time. Software-reconfigurable terminals such as those described in U.S. Pat. No. 6,185,418 are an example of intelligent terminals of this kind. With previous handover methods, in order to ensure a continuous data exchange for the operation of mobile terminals between the data transmission system and the terminal also in the event of a handover, in other words the changeover of the terminal from a first to a second serving transceiver device, the data stream was redirected locally to the corresponding network components of the second transceiver device. This has the critical disadvantage that potentially with each handover, in other words with each changeover of the terminal to a different transceiver device, the path of the data stream is lengthened as a result of the redirection and consequently an increased network load is produced due to the corresponding data traffic. This leads to an unnecessary occupation of transmission capacities within the mobile data transmission system on the one hand, while on the other hand it may no longer be possible to guarantee a requisite quality of the data transmission due to the extended transit delays.

The object of the present invention is therefore to provide an improved means of performing a handover in a mobile data transmission system for data transmissions, in particular in the downlink direction. This object is achieved by the specific features of the independent claims. Advantageous embodiments of the invention can be derived from the individual dependent claims.

A first subject matter of the present invention is a method for performing a handover of a mobile terminal in a mobile data transmission system from a first transceiver device of the mobile data transmission system to a second transceiver device during a data exchange between the mobile data transmission system and the mobile terminal. According to the invention, in the downlink direction of the data exchange from the mobile data transmission system to the mobile terminal the data to be transmitted is forwarded in parallel to a plurality of data buffers within the mobile data transmission system. The data buffers are assigned to switching devices and/or transceiver devices of the mobile data transmission system. Prior to the handover the data exchange between the mobile data transmission system and the mobile terminal takes place using a first data buffer, and after the handover the data exchange between the mobile data transmission system and the mobile terminal takes place using a second data buffer.

Thanks to this method a redirection of the data stream can be dispensed with and the risk of an ever-lengthening path of the data stream within the mobile data transmission system is eliminated. Rather, right from the outset the data to be transmitted to the mobile terminal is supplied in parallel to a plurality of data buffers with the result that the corresponding data is present redundantly in the data transmission system. A data exchange can then take place directly between the terminal and the nearest data buffer residing within the architecture of the data transmission system in each case, so the paths of the data stream are therefore optimized significantly.

One means of implementing a continuous data transmission without data losses between the terminal and the data transmission system is that the end of the data exchange with the first data buffer is indicated by the mobile terminal and this indicator is transmitted to the second transceiver device in order to continue the data exchange with the second data buffer. Relative or absolute addressing of the last data successfully transmitted to the terminal can for example be used as an indicator. In this way the terminal itself can monitor the complete reception of the data and if necessary take control or actively access the data made available in the data transmission system.

In order to organize the forwarding of the data to be transmitted to the terminal as efficiently as possible within the data transmission system, provision can be made in particular for the data to be transmitted to the mobile terminal—either automatically or controlled by a request by the mobile terminal—to be transmitted in hierarchical fashion in each case from a higher hierarchy level of the data buffers to a lower hierarchy level of the data buffer. In this scheme different data can be made available at different hierarchy levels of the data buffers, for example according to the importance of the data to be transmitted or according to the number of terminals that require this data. If, for example, data is provided for transmission for the purpose of updating all terminals, it may be more efficient to make this data available on the widest possible scale within the data transmission system, in other words at the lowest possible hierarchy level. If, however, the data concerns only individual terminals or only a single terminal, in order to increase the efficiency of the data transmission traffic within the data transmission system provision can be made for this data to be made available at a higher hierarchy level of the data buffers.

In particular the handover method can be performed using a hierarchical data storage structure such that the indicator transmitted by the mobile terminal is forwarded to the lowest hierarchy level of the data buffers and initially a check is made within this hierarchy level to determine the availability of the data to be transmitted to the terminal. If the data to be transmitted is available within the data buffer of this hierarchy level, an immediate continuation of the data transmission to the mobile terminal can take place starting from the data buffer of the lowest hierarchy level. However, if the data to be transmitted is not available in the data buffer of this hierarchy level, a request is first sent to a higher hierarchy level of the data buffers for transmission of the data to the lowest hierarchy level of the data buffers and then, in other words after the transmission of the data to the data buffer of the lower hierarchy level has been completed, the data transmission to the mobile terminal is continued starting from the data buffer of the lowest hierarchy level.

A further subject matter of the present invention is a mobile data transmission system having a plurality of transceiver devices and switching devices for the data exchange with mobile terminals. According to the present invention, a plurality of data buffers are provided within the mobile data transmission system, which data buffers are assigned to switching devices and/or transceiver devices of the mobile data transmission system, and are designed for storing data which is to be transmitted to a mobile terminal. This enables the data to be transmitted to a terminal within the data transmission system to be made available redundantly in a plurality of data buffers. During a handover of the terminal from one transceiver device to a further transceiver device there is then no need to reroute the data stream, as already described above, but instead the data residing redundantly in the corresponding data buffers can be accessed directly. The resulting advantages have already been explained in the context of the above-described method according to the invention.

Provision can advantageously be made for the mobile data transmission system to have a hierarchical network structure comprising transceiver devices and switching devices and higher-level network structures and for the data buffers likewise to have a hierarchical structure in which each hierarchy level corresponds to an equivalent hierarchy level of the network structure of the mobile data transmission system.

The structure of the data buffers thus forms a kind of overlaid network superimposed on the network structure of the data transmission system, whereby an assignment of the hierarchy level of the data buffers to the hierarchy levels of the data transmission system is provided in addition.

A special means of achieving an efficient data exchange between a mobile terminal and a hierarchical structure of data buffers as described in the foregoing can be implemented by an arrangement in which at least the data buffers of the lowest hierarchy levels are assigned a device which is designed to check the availability of the data to be transmitted in the corresponding data buffer and, in the event of said data not being available, to initiate a transmission of the data to be transmitted from a higher hierarchy level of the data buffers to the assigned data buffer. This can remove the need for the data to be transmitted to a terminal to be made available at every hierarchy level or in all the data buffers of the lowest hierarchy level, which could mean too high a data storage overhead particularly in the case of data intended only for a specific terminal. Rather, as already explained with reference to the method described in the foregoing, the data can be made available at a suitable hierarchy level, for example according to importance or need. The device for checking the availability of the data and for initiating a data transmission can be implemented either using devices that are already present within the data transmission system or using suitable additional devices.

Finally the present invention comprises a mobile terminal for a mobile data transmission system having a plurality of transceiver devices and switching devices enabling data exchange with mobile terminals. According to the invention the mobile terminal comprises a device for indicating the end of a data exchange via a first transceiver device with a first data buffer and for transmitting the indicator to a second transceiver device. By means of such a device the end of the data transmission from a first transceiver device to the terminal can be indicated on the part of the terminal in the course of a handover and upon completion of a handover to a second transceiver device controlled by a request by the terminal for the second transceiver device to resume the data transmission. This allows simple and effective control of the data transmission in the course of a handover. This can take place advantageously in particular when the data to be transmitted to the terminal is present redundantly in the data transmission system, as described above.

In particular the mobile terminal can be implemented as a software-reconfigurable terminal, as they are essentially known from the prior art. For terminals of this kind in particular there is frequently need for a data transmission to the terminal, for which reason the data transmission is to be handled as efficiently as possible. On the other hand such terminals are particularly suitable for processing larger data transmissions from the data transmission system to the terminal.

A special exemplary embodiment is explained in the following with reference to FIGS. 1 to 3, in which:

FIG. 1: shows a handover method in a mobile data transmission system according to the prior art

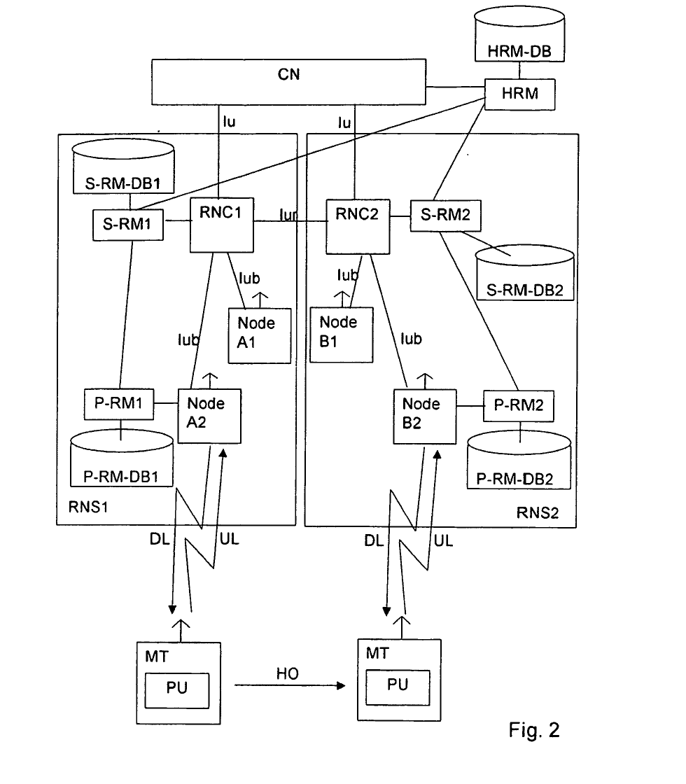

FIG. 2: shows a data transmission system and terminal according to the invention for a method according to the invention

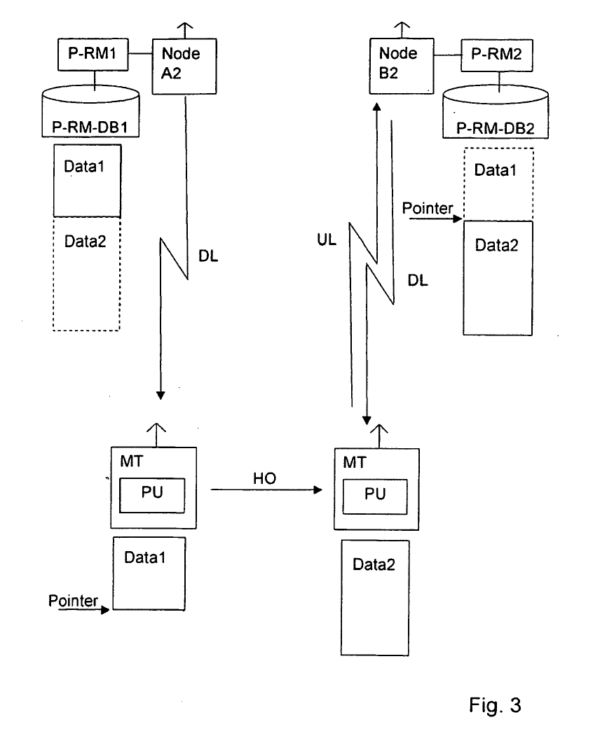

FIG. 3: shows a schematic representation of a data transmission according to the invention to a terminal during a handover

FIG. 1 shows the execution sequence for a handover according to the prior art, for example in a HIPERLAN or HIPERLAN/2 network or a UMTS network. In this case the mobile data transmission system according to the prior art comprises a plurality of subsystems RNS1, RNS2 (Radio Network Subsystem) in which the data traffic is managed in each case by a switching device RNC (Radio Network Controller). These subsystems RNS1, RNS2 are linked to higher-level network structures CN (Core Network) via a data interface Iu. The switching devices RNC are in turn connected to one another via a further data interface Iur, which thus also forms the data interface between individual subunits. The switching devices RNC are further connected via a data interface Iub to transceiver devices (Node A1, Node A2, Node B1, Node B2) which set up a mobile radio data connection to mobile terminals MT via a defined radio interface and cover one or more individual radio cells. The data connection from the mobile data transmission system to the terminal MT is referred to here as the downlink direction (downlink DL), while the data connection from the terminal MT to the mobile data transmission system is known as the uplink direction (uplink UL).

FIG. 1 thus shows the usual method according to the prior art, wherein before a handover HO of the mobile terminal from a first subsystem RNS1 to a second subsystem RNS2—or from a first transceiver device Node A2 to a second transceiver device Node B2—a data stream is routed from the core network CN via the interface Iu to the switching device RNC of a first subsystem RNS1, with the switching device then acting as a serving RNC (SRNC). This forwards the data stream to a transceiver device Node A2 of the subsystem RNS1, which sets up a bidirectional radio connection UL, DL to the corresponding mobile terminal MT.

If the handover HO of the terminal MT to the second subsystem RNS2 now takes place, the serving RNC (SRNC) forwards the data stream via the data interface Iur to the RNC of the second subsystem RNS2, which then acts as a drift RNC (DRNC). This then forwards the data stream in turn to a transceiver device Node B2 of the second subsystem RNS2, which sets up a bidirectional radio connection UL, DL to the terminal MT to enable continuation of the data transmission between data transmission system and terminal MT. The thickly drawn arrows in FIG. 1 schematically represent the path of the data stream after the handover HO, from which it can be seen that the path has been lengthened compared with the status prior to the handover as a result of the redirection from the SRNC via the interface Iur to the DRNC. There is therefore the risk, in particular with multiple handover, of a considerably increased network load and reduced data transmission quality QoS (Quality of Service).

In addition to the network components already described with reference to FIG. 1, FIG. 2 shows a data transmission system according to the invention which has a hierarchical data storage structure comprising data buffers HRM-DB, S-RM-DB and P-RM-DB from different hierarchy levels. Each hierarchy level of the data buffers HRM-DB, S-RM-DB and P-RM-DB corresponds in this case to a hierarchy level CN, RNC, Node A1 to Node B2 of the structure of the data transmission system. In addition each of the data buffers is assigned management devices HRM, S-RM, P-RM which in particular check the availability of requested data in the respective data buffers. Thus, the core network CN is connected to a data buffer HRM-DB, to which a so-called home reconfiguration manager HRM is assigned. Each RNC of a subsystem RNS1, RNS2 is connected to a data buffer S-RM-DB, to which a serving reconfiguration manager S-RM is assigned. Each of the transceiver devices Node A1 to Node B2 of each subsystem RNS1, RNS2 is connected to a data buffer P-RM-DB, to which a proxy reconfiguration manager P-RM is assigned in each case.

The HRM is connected to each S-RM, and each S-RM is connected to each P-RM of the corresponding subsystem RNS. Although for the sake of simplicity only one P-RM and one P-RM-DB per subsystem RNS are shown in each case in FIG. 2, each of the other transceiver devices Node A1, Node B1 has a P-RM and a P-RM-DB. This results in a hierarchical structure of data buffers and assigned reconfiguration managers RM which is overlaid on the similarly hierarchical structure of the data transmission system.

The terminals MT are to be embodied as software-reconfigurable terminals. They also comprise a device which is designed to indicate the end (interrupt) of a data exchange with the serving transceiver device and is to be referred to here as a pointer unit PU.

The handover method according to the invention will now be explained by way of example with reference to FIG. 2 and 3. Prior to a handover HO of the terminal MT, the data to be transmitted to the terminal MT in the downlink DL is made available in the data buffer HRM-DB. Depending on the importance of the data, the data can now be transmitted to all the data buffers S-RM-DB for example under the control of the HRM, in other words to S-RM-DB1 and S-RM-DB2 in the example shown in FIG. 2. Depending on the importance of the data, S-RM1 and S-RM2 can now in their turn initiate a transmission to the data buffers P-RM-DB1 and P-RM-DB2 of the associated subsystem RNS1, RNS2. A transmission of this kind down to the lowest hierarchy level can be performed for example for a software reconfiguration of all terminals MT, since in such a case the data must be available on a broad scale for all terminals MT.

In the example presented here, as shown in FIG. 3, all the data Data1, Data2 in all data buffers P-RM-DB1, P-RM-DB2 of the lowest hierarchy level is therefore present prior to the handover HO. The data now begins to be transmitted to the terminal MT by the transceiver device Node A2 of the radio cell RNS1. Prior to the handover the data Data1 is successfully transmitted to the terminal MT. However, the data Data2 can no longer be transmitted to the terminal MT before the handover HO. With the aid of the pointer unit PU the terminal indicates the end of the data transmission from the radio cell RNS1 by means of a suitable pointer which can contain in particular the respective address of the last successfully received data and where appropriate also a characterization of the associated data stream.

Following the handover of the terminal MT to the second subsystem RNS2, the terminal MT then sends a request for continuation of the data transmission to the subsystem RNS2, said request containing a pointer (DatastreamX, AddressY) which indicates at which point the data transmission to the terminal MT is to be resumed. In the transceiver device a connection is then set up to the assigned reconfiguration manager P-RM2, which checks whether the requested data Data2 indicated by the pointer is available in the data buffer P-RM-DB2 of this hierarchy level. If this data is available, the data Data2 is retrieved from the data buffer P-RM-DB2 and transmitted to the terminal MT via the transceiver device Node B2 of the subsystem RNS2. This case is illustrated in FIG. 3. However, should the data not be available in the data buffer P-RM-DB2 of the lowest hierarchy level, the request is forwarded by the reconfiguration manager P-RM2 to the higher-level reconfiguration manager S-RM2, which in turn checks the availability of the data in the assigned data buffer S-RM-DB2 of the now next-higher hierarchy level. If the data is available there, it is transmitted by the S-RM2 to the lower hierarchy level P-RM-DB2 and from there to the terminal MT. If the data is also not available in the data buffer S-RM-DB2, the request is forwarded to an even higher hierarchy level HRM.

A central advantage of the invention is that the path of the data transmission following a handover no longer runs, as in the prior art, through a plurality of subsystems RNS1, RNS2, but henceforth only through a single subsystem RNS2, and that in addition particularly important data can be made available directly for all transceiver devices Node A1 to Node B2 for direct access by the terminals MT.

1. Method for performing a handover (HO) of a mobile terminal (MT) in a data transmission system from a first transceiver device (Node A2) of the data transmission system to a second transceiver device (Node B2) during a data exchange between the data transmission system and the mobile terminal (MT),
wherein
during the data transmission in the downlink direction (DL) to the mobile terminal (MT) the data (Data1, Data2) to be transmitted is forwarded in parallel to a plurality of data buffers (P-RM, S-RM) of the data transmission system, and the data transmission is performed prior to the handover (HO) from a first data buffer (P-RM-DB2) and following the handover (HO) from a second data buffer (P-RM-DB3) to the mobile terminal (MT), whereby the data (Data1, Data2) to be transmitted to the mobile terminal (MT) is transmitted hierarchically in each case either automatically or controlled by a request by the mobile terminal (MT) from a higher hierarchy level of the data buffers (P-RM-DB, S-RM-DB, HRM-DB) to a lower hierarchy level of the data buffers (P-RM-DB, S-RM-DB, HRM-DB), and whereby each hierarchy level of the data buffers (P-RM-DB, S-RM-DB, HRM-DB) corresponds to a hierarchy level of the network structure of the data transmission system.

2. Method according to claim 1,
characterized in that
each of the data buffers (P-RM, S-PM) is assigned at least to one switching device (RNC1, RNC2) and/or transceiver device (Node A1, Node A2, Node B1, Node B2) of the data transmission system.

3. Method according to claim 1 or 2,
characterized in that
the end of the data transmission from the first data buffer (P-PM-DB2) is indicated by the mobile terminal (MT) and this indicator (pointer) is transmitted for the purpose of continuing the data transmission from the second data buffer (P-RM-DB3).

4. Method according to claim 3,
characterized in that
the indicator transmitted by the mobile terminal (MT) is forwarded to the lowest hierarchy level of the data buffers (P-RM-DB, S-RM-DB, HRM-DB), a check is performed within this hierarchy level to determine the availability of the data (Data1, Data2) to be transmitted to the terminal (MT), and
if the data (Data1, Data2) to be transmitted is available, an immediate continuation of the data transmission to the mobile terminal (MT) takes place starting from the data buffer (P-RM-DB, S-RM-DB, HRM-DB) of the lowest hierarchy level,
if the data (Data1, Data2) to be transmitted is not available, a request is first made to a higher hierarchy level of the data buffers (P-RM-DB, S-RM-DB, HRM-DB) for transmission of the data (Data1, Data2) to the lowest hierarchy level of the data buffers (P-RM-DB, S-RM-DB, HRM-DB) and then the data transmission to the mobile terminal (MT) is resumed starting from the data buffer (P-RM-DB, S-RM-DB, HRM-DB) of the lowest hierarchy level.

5. Data transmission system having a plurality of transceiver devices (Node A1, Node A2, Node B1, Node B2) and switching devices (RNC1, RNC2) for the purpose of data exchange with mobile terminals (MT),
characterized in that
there is provided within the data transmission system a plurality of data buffers (P-RM-DB, S-RM-DB, HRM-DB) which are assigned to switching devices (RNC1, RNC2) and/or transceiver devices (Node A1, Node A2, Node B1, Node B2) of the mobile data transmission system and which are designed to store data (Data1, Data2) which can be transmitted to a mobile terminal (MT), and that the data transmission system has a hierarchical network structure comprising transceiver devices (Node A1, Node A2, Node B1, Node B2) and switching devices (RNC1, RNC2) and higher-level network structures (CN) and the data buffers (P-RM-DB, S-RM-DB, HRM-DB) likewise have a hierarchical structure in which each hierarchy level corresponds to an equivalent hierarchy level of the network structure of the data transmission system.

6. Data transmission system according to claim 5,
characterized in that
at least the data buffers (P-RM-DB, S-RM-DB, HRM-DB) of the lowest hierarchy levels are assigned a device (P-RM, S-RM, HRM) which is designed to check that the data (Data1, Data2) to be transmitted is available in the corresponding data buffer (P-RM-DB, S-RM-DB, HRM-DB) and, if the data (Data1, Data2) to be transmitted is not available, to initiate a transmission of said data from a higher hierarchy level of the data buffers (P-RM-DB, S-RM-DB, HRM-DB) to the assigned data buffer (P-RM-DB, S-RM-DB, HRM-DB).

7. Mobile terminal (MT) for a data transmission system having a plurality of transceiver devices (Node A1, Node A2, Node B1, Node B2) and switching devices (RNC1, RNC2) for the purpose of data exchange with mobile terminals (MT),
characterized in that
the mobile terminal (MT) has a device (PU) for indicating (pointer) the end of a data transmission from a first data buffer (P-RM-DB2) via a first transceiver device (Node A2) and for transmitting an indicator (pointer) to a second transceiver device (Node A2, Node B2).

8. Mobile terminal according to claim 7,
characterized in that
the mobile terminal (MT) is designed as a software-reconfigurable terminal.
